(19) United States
(12) Patent Application Publication
(10) Pub. No.: US 2013/0334180 A1
(43) Pub. Date: Dec. 19, 2013

(54) AUTOMATIC COMPOUND FEEDING AND RECALLING LASER PROCESSING EQUIPMENT

(71) Applicants: Che-Min KUNG, New Taipei City (TW); Chih-Lin Chen, New Taipei City (TW); Ming-Che Su, New Taipei City (TW); Jung-Yie Wu, New Taipei City (TW)

(72) Inventors: Che-Min KUNG, New Taipei City (TW); Chih-Lin Chen, New Taipei City (TW); Ming-Che Su, New Taipei City (TW); Jung-Yie Wu, New Taipei City (TW)

(21) Appl. No.: 13/495,804

(22) Filed: Jun. 13, 2012

(51) Int. Cl. B23K 26/00

(52) U.S. Cl. 219/121.39

(57) ABSTRACT

An automatic compound feeding and recalling laser processing equipment comprising a laser processing machine, a laser mechanism for laser processing and a working platform being disposed in the laser processing machine; a feeding machine and a recalling machine disposing at two opposite ends of the laser processing machine respectively. A feeding shaft is disposed in the feeding machine for unreeling a roll of to-be-processed strip workpiece so that the strip workpiece is passed through the working platform to be processed by laser. A recalling shaft is disposed in the recalling machine for reeling the processed strip workpiece. Thereby, the laser processing can be performed continuously and mass production can be achieved speedily.

### BACKGROUND OF THE INVENTION

1. Field of Invention

The present invention relates to an automatic compound feeding and recalling laser processing equipment and more particularly to a laser processing machine with a set of roll-to-roll unreeling and reeling device disposed at two opposite ends of the laser processing machine for processing a roll of strip workpiece by laser.

2. Related Art

Laser processing machine is widely used because of its advantages of extensive applicability, high precise processing and speedy cutting. A conventional laser processing machine is mainly composed of a panel and a bottom base connected together to form a machine body. A laser mechanism, a working platform and an air box are disposed in the machine body. The air box is connected under the working platform and the laser mechanism is disposed above the working platform. Thereby, when a workpiece on the working platform is processed by the laser mechanism, the chips and smoke produced are discharged from the air box under the working platform and a ventilation exit at the back of the air box. Therefore, the chips can be discharged and heat can be dissipated by the air box.

When the above laser processing machine is used, the workpieces are feed one at a time and the feeding process is performed under a discontinuous mode. The to-be-processed flat and thin workpieces are placed on the working platform one by one by manpower for the processes of cutting and engraving by laser. However, with such an operational mode, bottlenecks of long manufacturing time, small processed area and increased amount of wasted material occur in the processing. Therefore, the applicability of the laser processing machine is limited and the drawbacks are needed to be improved.

In order to improve the above drawbacks, an automatic compound feeding and recalling laser processing equipment is provided. A transportation path is formed between a feeding machine and a recalling machine disposed at the left and right ends of a laser processing machine respectively. Thereby, a roll of to-be-processed strip workpiece can be processed by laser by the laser processing machine with a roll-to-roll continuous manufacturing mode.

### SUMMARY OF THE INVENTION

A primary objective of the present invention is to provide an automatic compound feeding and recalling laser processing equipment. A feeding machine and a recalling machine are disposed at two opposite ends of a laser processing machine respectively. A transportation path for a roll of strip workpiece is formed on a working platform so that the strip workpiece can pass through the working platform consistently and automatically and be processed by laser. Thereby, both the efficiency of operation and the availability factor of the entire roll of strip workpiece can be enhanced.

In order to achieve the above-mentioned objective, the present invention of an automatic compound feeding and recalling laser processing equipment comprises a laser processing machine, a feeding machine and a recalling machine. A laser mechanism for laser processing and a working platform are disposed in the laser processing machine. The feeding machine and the recalling machine are disposed at two opposite ends of the laser processing machine respectively. A feeding shaft is disposed in the feeding machine for unreeling a roll of to-be-processed strip workpiece so that the strip workpiece is passed through the working platform to be processed by laser. A recalling shaft is disposed in the recalling machine for reeling the processed strip workpiece.

When the automatic compound feeding and recalling laser processing equipment is embodied, a plurality of transportation rollers is disposed in the feeding machine and the recalling machine respectively for transporting the strip workpiece to pass through the working platform.

When the automatic compound feeding and recalling laser processing equipment is embodied, a feeding end connection portion and a recalling end connection portion are disposed at sides of the laser processing machine corresponding to the feeding machine and the recalling machine respectively for connecting and positioning the feeding machine and the recalling machine.

When the automatic compound feeding and recalling laser processing equipment is embodied, the laser processing machine is electrically connected with the feeding machine and the recalling machine via the feeding end connection portion and the recalling end connection portion respectively.

When the automatic compound feeding and recalling laser processing equipment is embodied, a strip material sensing mechanism is further disposed in the feeding machine for sensing the displacement statuses of the strip workpiece.

The present invention will become more fully understood by reference to the following detailed description thereof when read in conjunction with the attached drawings.

### BRIEF DESCRIPTION OF THE DRAWINGS

FIG. 1 is a perspective view of an automatic compound feeding and recalling laser processing equipment according to an embodiment of the present invention;

FIG. 2 is a side view of a feeding machine and a recalling machine in operation according to the embodiment in FIG. 1;

FIG. 3 is a side view of a long flat strip workpiece being processed by laser according to the embodiment in FIG. 1; and

FIG. 4 is an operational flow chart of the embodiment in FIG. 1.

### DETAILED DESCRIPTION OF THE INVENTION

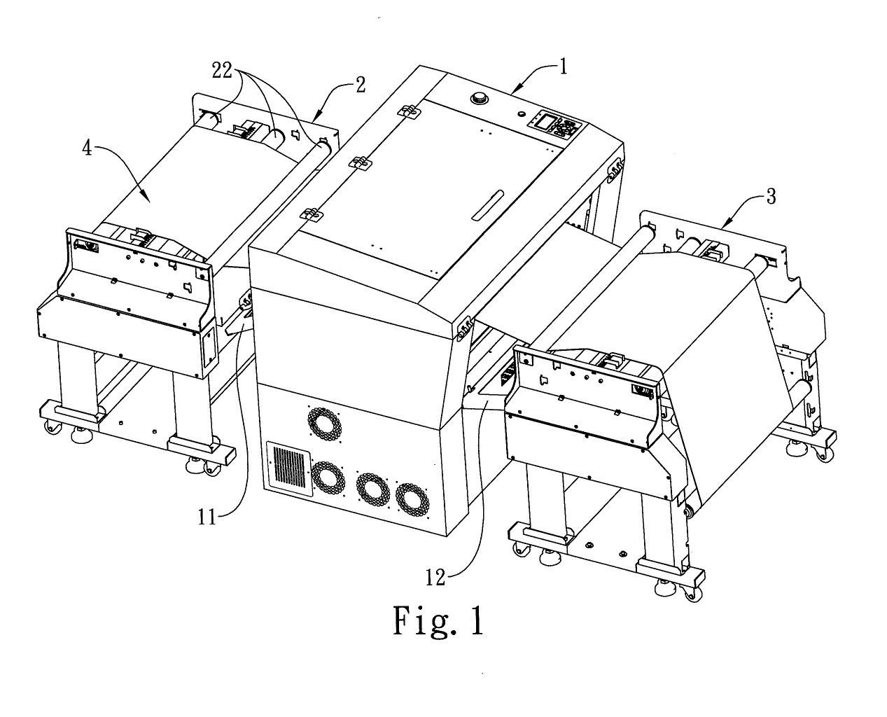

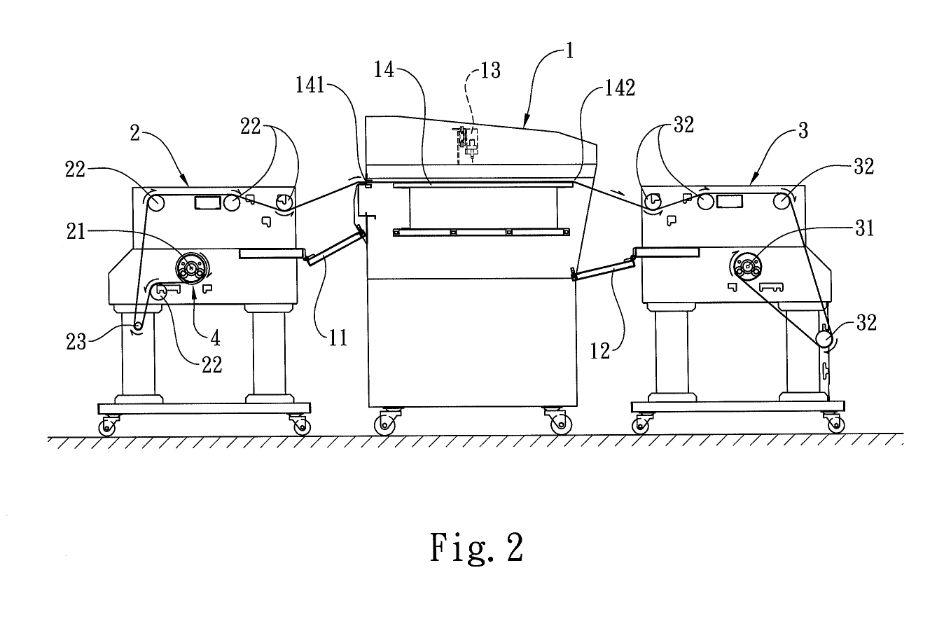

FIG. 1 is a perspective view of an automatic compound feeding and recalling laser processing equipment according to an embodiment of the present invention; and FIG. 2 is a side view of a feeding machine and a recalling machine in operation according to the embodiment in FIG. 1. The automatic compound feeding and recalling laser processing equipment comprises a laser processing machine 1, a feeding machine 2 and a recalling machine 3. A feeding end connection portion 11 and a recalling end connection portion 12 are disposed at the left and right sides of the laser processing machine 1 respectively. A laser mechanism 13 for laser processing and a working platform 14 are disposed in the laser processing machine 1. A feeding end 141 and an outlet end 142 are disposed at the left and right ends of the working platform 14 respectively.

The feeding machine 2 and the recalling machine 3 are disposed at the left and right ends of the laser processing machine 1 respectively for connecting with the feeding end connection portion 11 and the recalling end connection portion 12 respectively so that the feeding machine 2 and the recalling machine 3 are fixed by the left and right ends of the laser processing machine 1. A feeding shaft 21, a plurality of transportation rollers 22 and a strip material sensing mechanism 23 are disposed in the feeding machine 2. A recalling shaft 31 and a plurality of transportation rollers 32 are disposed in the recalling machine 3. Thereby, the feeding machine 2 and the recalling machine 3 are formed as a roll-to-roll device.

When the automatic compound feeding and recalling laser processing equipment is embodied, a roll of to-be-process strip workpiece 4 is reeled around the feeding shaft 21. The feeding shaft 21 is driven to rotate clockwise by a driving device (not shown in the figures) so that the roll of to-be-process strip workpiece 4 is unreeled. The unreeled strip workpiece 4 is rolled through the strip material sensing mechanism 23 of the feeding machine 2, and rolled over the transportation rollers 22. The unreeled strip workpiece 4 is then passed through the working platform 14 from the feeding end 141 and is processed by laser by the laser mechanism 13 (e.g. the strip workpiece 4 is processed with cutting or engraving by laser). The displacement statuses, such as feeding speed, output quantity and left and right translational motion, of the strip workpiece 4 transported on the working platform 14 is sensed by the strip material sensing mechanism 23. Then, the recalling shaft 31 is driven by a driving device (not shown in the figures) to rotate clockwise to reel the processed strip workpiece 4 departed from the working platform 14 via the outlet end 142. The processed strip workpiece 4 from the outlet end 142 is finally reeled around the recalling shaft 31 after passing over the transportation rollers 32 of the recalling machine 3.

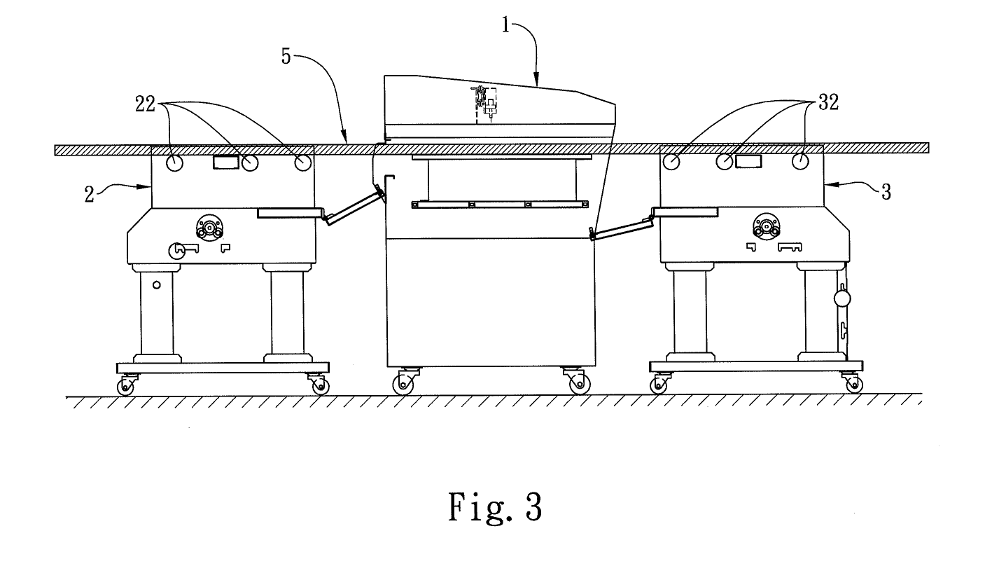

As shown in FIG. 3, when the automatic compound feeding and recalling laser processing equipment is embodied, a long flat strip workpiece 5 can be supported by the transportation rollers 22 and 32 disposed on a top level of the feeding machine 2 and the recalling machine 3 so that the long flat workpiece 5 can be processed by laser by the laser processing machine 1.

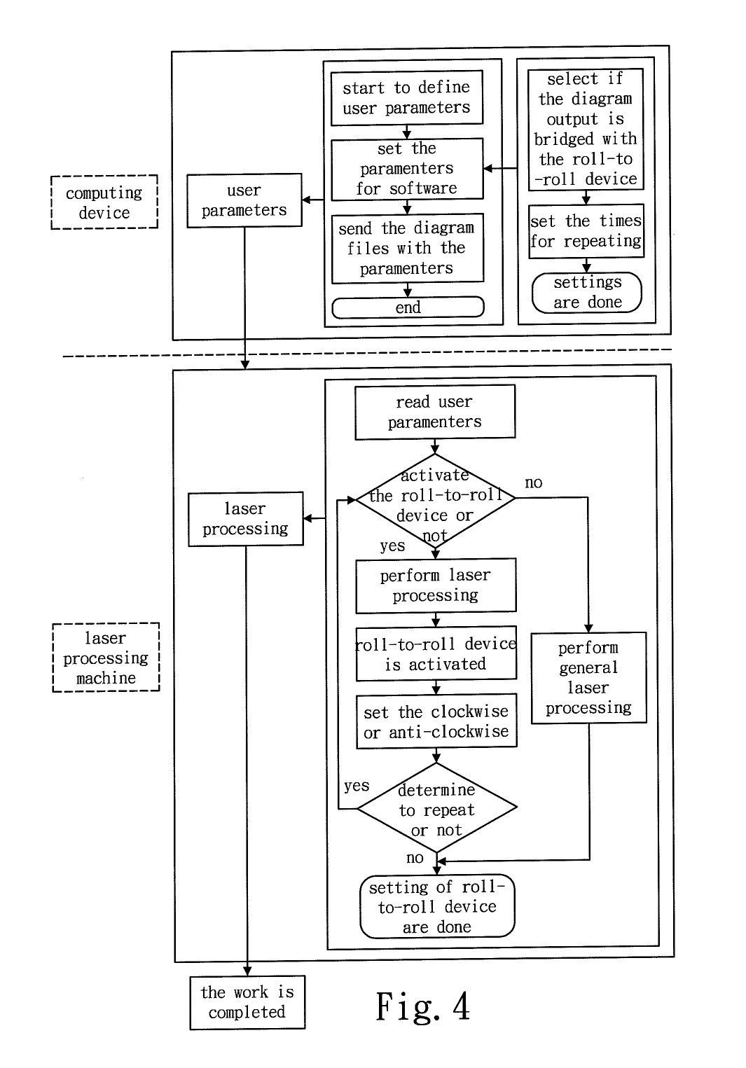

FIG. 4 is an operational flow chart of the automatic compound feeding and recalling laser processing equipment. The laser processing machine 1 is electrically connected with the feeding machine 2 and the recalling machine 3 via the feeding end connection portion 11 and the recalling end connection portion 12 respectively. Therefore, the laser processing machine 1, the feeding machine 2 and the recalling machine 3 can be controlled simultaneously by a computing device to operate, and the displacement statuses of the unreeled strip workpiece 4 can be sensed automatically. Before the laser processing is performed, following initial settings are set by the computing device sequentially:

1. select if the diagram output is bridged with the roll-to-roll device;

2. set the times for repeating the work;

after the settings are done, following advanced settings are set for the diagrams sequentially:

1. start to define user parameters;

2. set the parameters for software;

3. send the diagram files with the parameters;

after the advanced settings are set for the diagram files, the defined user parameters are sent to the laser processing machine 1, after the user parameters from the computing device are read by the laser processing machine 1, select if the roll-to-roll device is activated; if select not to activate the roll-to-roll device, general laser processing is performed directly until the work is completed; if select to activate the roll-to-roll device, the roll-to-roll device is activated at the same time when laser processing is performed, after laser processing is completed, set the clockwise or anti-clockwise rotating direction of the feeding shaft 21 and the recalling shaft 31, and select if the motion of the roll-to-roll device is repeated and determine again if the roll-to-roll device is activated until the work is completed. Thereby, by setting the rotating directions of the feeding shaft 21 and the recalling shaft 31, the strip workpiece 4 can be transported backward and forward for processing by laser on the working platform 14. Therefore, the laser processing machine 1 can perform more delicate and complicated laser processing.

Therefore, the automatic compound feeding and recalling laser processing equipment of the present invention has the following advantages:

1. The continuous laser processing of the present invention is innovative in comparing with the operational method of conventional laser processing machines. By forming the transportation path on the working platform for the strip workpiece with the employment of the roll-to-roll device, and by transporting the strip workpiece backward and forward for processing by laser; workpieces made with a wide variety of materials can be processed, the workpieces can be processed more delicately and the production can be performed continuously.

2. The time required for feeding the workpieces one by one by manpower can be saved, the amount of wasted material left from the workpieces can be reduced, the manufacturing speed can be enhanced and the amount of raw material used can be reduced. Thereby, both the practicability and competitiveness of the laser processing machine are enhanced.

As a conclusion from the above, the present invention can certainly achieve the expected objectives by providing the automatic compound feeding and recalling laser processing equipment. The roll of to-be-processed strip workpiece is processed by laser by employing the roll-to-roll continuous manufacturing process. Thereby, the production efficiency can be enhanced and the production cost can be reduced.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. An automatic compound feeding and recalling laser processing equipment, comprising:
a laser processing machine, being disposed with a laser mechanism for laser processing and a working platform; and
a feeding machine and a recalling machine being disposed at two opposite ends of the laser processing machine respectively, wherein a feeding shaft is disposed in the feeding machine for unreeling a roll of to-be-processed strip workpiece so that the strip workpiece is passed through the working platform to be processed by laser, and a recalling shaft is disposed in the recalling machine for reeling the processed strip workpiece.

2. The automatic compound feeding and recalling laser processing equipment as claimed in claim 1, wherein a plurality of transportation rollers is disposed in the feeding machine and the recalling machine respectively for transporting the strip workpiece to pass through the working platform.

3. The automatic compound feeding and recalling laser processing equipment as claimed in claim 2, wherein a feeding end connection portion and a recalling end connection portion are disposed at sides of the laser processing machine corresponding to the feeding machine and the recalling machine respectively for connecting and positioning the feeding machine and the recalling machine.

4. The automatic compound feeding and recalling laser processing equipment as claimed in claim 3, wherein the laser processing machine is electrically connected with the feeding machine and the recalling machine via the feeding end connection portion and the recalling end connection portion respectively.

5. The automatic compound feeding and recalling laser processing equipment as claimed in claim 4, wherein a strip material sensing mechanism is further disposed in the feeding machine for sensing the displacement statuses of the strip workpiece.
